(19) United States
(12) Patent Application Publication
(10) Pub. No.: US 2005/0256793 A1
(43) Pub. Date: Nov. 17, 2005

(54) Multiple seller securitization for transforming private equity exposure

(76) Inventors: Hiram Hamilton, New York, NY (US); Tomer Regev, Forest Hills, NY (US); J. Douglas Van Ness, Greenwich, CT (US)

Correspondence Address: KIRKPATRICK & LOCKHART NICHOLSON GRAHAM LLP, 535 SMITHFIELD STREET, PITTSBURGH, PA, 15222, US

(21) Appl. No.: 11/058,335

(22) Filed: Feb. 15, 2005

Related U.S. Application Data
(63) Continuation of application No. 10/847,528, filed on May 17, 2004, now abandoned.

(51) Int. Cl. G06F 17/60

(52) U.S. Cl. 705/35; 705/42; 705/36

(57) ABSTRACT

Embodiments of a multi-seller securitization structure include an issuer structured to receive at least one asset portion from each seller of a plurality of sellers, with each asset portion comprising an asset support pool of a total asset pool of the issuer. The issuer is structured to issue at least two tranches of financial instruments, wherein a first tranche includes at least one senior instrument, and a second tranche includes at least one subordinated instrument. The second tranche includes a plurality of subtranches, at least one of which is structured to be associated with at least one of the asset support pools. Also, the issuer is structured for making at least one make-whole payment in connection with at least one make-whole amount tracked by the issuer in association with at least one of the asset support pools.

### BACKGROUND

Private equity is a core asset class for many institutions because of its potential for superior return characteristics and the benefits it may offer in the form of investment portfolio diversification. Investors continue to seek efficient ways to maintain exposure to private equity as part of their overall investment strategies. As an asset class, however, private equity is typically illiquid and highly capital intensive for certain institutional investors. Due to the illiquid nature of the collateral, selling private equity interests is difficult and may result in a sale price that is at a discount to fair market value.

Private equity is also a core asset class for many high net worth individuals and families. Similar to institutions, individuals benefit from its potential for superior returns which are generally correlated to the broader equity and fixed income markets. One unique aspect of private equity fund investments as an asset class is that a private equity commitment is made at the closing of the fund and capital is called over time (draw downs). Liquidity problems can arise for investors that experience a material drop in net worth or a decrease in cash available. As previously discussed, due to an illiquid secondary market, transferring the obligation to fund such capital calls (i.e., transferring interests in the fund) is difficult and typically expensive.

Historically, single sponsor securitizations have been employed by institutions as a mechanism to leverage the benefits and minimize the disadvantages associated with holding interests in private equity. Historically, a seller/sponsor has established a qualifying special purpose entity (“QSPE” as defined under FAS 140) to serve as an issuer or other financial vehicle for a securitization structure. FAS 140 requires that a transferor of financial assets shall not consolidate a QSPE. This requirement is based on the view that the transferor has surrendered control of the transferred assets. Recent changes in relevant laws, regulations, rules, and/or policies, however, may impose restrictions on a QSPE including prohibitions against the QSPE holding equity related instruments (e.g., private equity interests). In addition, the seller/sponsor may be barred from providing liquidity to the QSPE. As a result, securitizing private equity via a QSPE may no longer achieve the same positive results when it is done by a single seller/sponsor.

Alternatively, a non-qualifying SPE (as opposed to a QSPE) could be used as an issuer. Consolidation of a non-qualifying SPE is subject to the requirements of FIN 46(R) (a QSPE is not subject to FIN 46(R)). The analysis of FIN 46(R) for consolidation versus non-consolidation focuses on whether or not any party bears the majority of the potential risks and rewards of the assets in the SPE. As a result, the sponsor cannot own a majority of the subordinated tranches of a securitization (where a majority of the risks and rewards resides) and at the same time achieve non-consolidation. Conventional multi-sponsor securitization structures typically pool the assets of all sponsor participants in a single vehicle, thereby burdening each sponsor with the credit risks and portfolio performance risks of every other sponsor participating in the securitization structure.

In view of the foregoing, it would be desirable to offer sponsors/sellers enhanced securitization structures that provide efficient exposure to private equity interests. Furthermore, improved securitization structures are needed that can provide desired accounting or tax treatment consequences for sellers/sponsors under applicable laws, regulations, rules and/or guidelines that govern private equity securitization. In addition, securitization structures are needed that minimize the burden of any one sponsor bearing the credit and portfolio performance risks associated with all other participants in a multi-sponsor structure.

### SUMMARY

The present invention includes various embodiments of a multi-seller securitization structure that includes an issuer structured to receive at least one asset portion from each seller of a plurality of sellers, with each asset portion comprising an asset support pool of a total asset pool of the issuer. The issuer is structured to issue at least two tranches of financial instruments, wherein a first tranche includes at least one senior instrument, and a second tranche includes at least one subordinated instrument. The second tranche may include a plurality of subtranches, wherein at least one of the subtranches is structured to be associated with at least one of the asset support pools. In addition, the issuer is structured for making at least one make-whole payment in connection with at least one make-whole amount tracked by the issuer in association with at least one of the asset support pools.

In various securitization structure embodiments, each of the asset support pools represents a corresponding percentage of the fair market value of the total asset support pool; at least one of the asset support pools supports at least one payment in association with at least one of the financial instruments in accordance with the corresponding percentage of the asset support pool; and/or the issuer is structured for tracking at least one the make-whole amount if at least one of the asset support pools cannot support the corresponding percentage payment.

In various securitization structure embodiments, at least one grouping of the plurality of subtranches may be structured for association with at least one of the asset support pools. At least one of the asset portions may include an equity interest that may also be a private equity interest or a public equity interest. In certain embodiments, at least one of the plurality of sellers may be an institution or an individual investor.

The present invention also provides embodiments of a method for structuring a multi-seller securitization structure. The method may include structuring an issuer to receive at least one asset portion from each seller of a plurality of sellers, with each asset portion comprising an asset support pool of a total asset pool of the issuer; and, structuring the issuer to issue at least two tranches of financial instruments, wherein a first tranche includes at least one senior instrument, and a second tranche includes at least one subordinated instrument. The second tranche may include a plurality of subtranches, at least one of which is structured to be associated with at least one of the asset support pools. Also, the method may include structuring the issuer for making at least one make-whole payment in connection with at least one make-whole amount tracked by the issuer in association with at least one of the asset support pools.

Other embodiments of the present invention will become apparent to those skilled in the art upon review of the following description and figures. It is intended that all such additional embodiments be within the scope of the present invention and be protected by the claims.

### BRIEF DESCRIPTION OF THE FIGURES

FIG. 1 includes a structural overview of a securitization provided in accordance with various embodiments of the present invention;

FIG. 2 includes a priority of payment process flow diagram provided in accordance with various embodiments of the present invention; and,

FIG. 3 includes a schematic diagram illustrating examples of various system and computer-readable media embodiments provided in accordance with the present invention.

### DESCRIPTION

A multiple seller securitization, as described in various embodiments herein, can be used by investors (particularly institutions) to achieve a more efficient exposure to private equity that requires less capital, creates leverage on a private equity portfolio, and generates proceeds without giving up exposure to transferred private equity portfolios; and can be used by investors (particularly individuals) to create a mechanism to fund ongoing capital calls and generate proceeds without a sale which might produce an economic loss. In addition, embodiments of multiple seller securitizations provided herein minimize the burden of any one sponsor/seller bearing the credit and portfolio performance risks associated with all other sponsor/seller participants in the securitization structure.

As applied herein to various embodiments, an “institution” that acts as a seller, investor or other entity may include, for example and without limitation, a bank, an insurance company, a pension fund, a private equity fund, an endowment, or a foundation.

As applied herein to various embodiments, an “individual” that acts as a seller, investor or other entity may include, for example and without limitation, qualified institutional buyers, accredited investors, or high net-worth individuals.

As applied herein to various embodiments, a “financial instrument” may include, for example and without limitation, a security, a loan, an equity instrument, or a debt instrument.

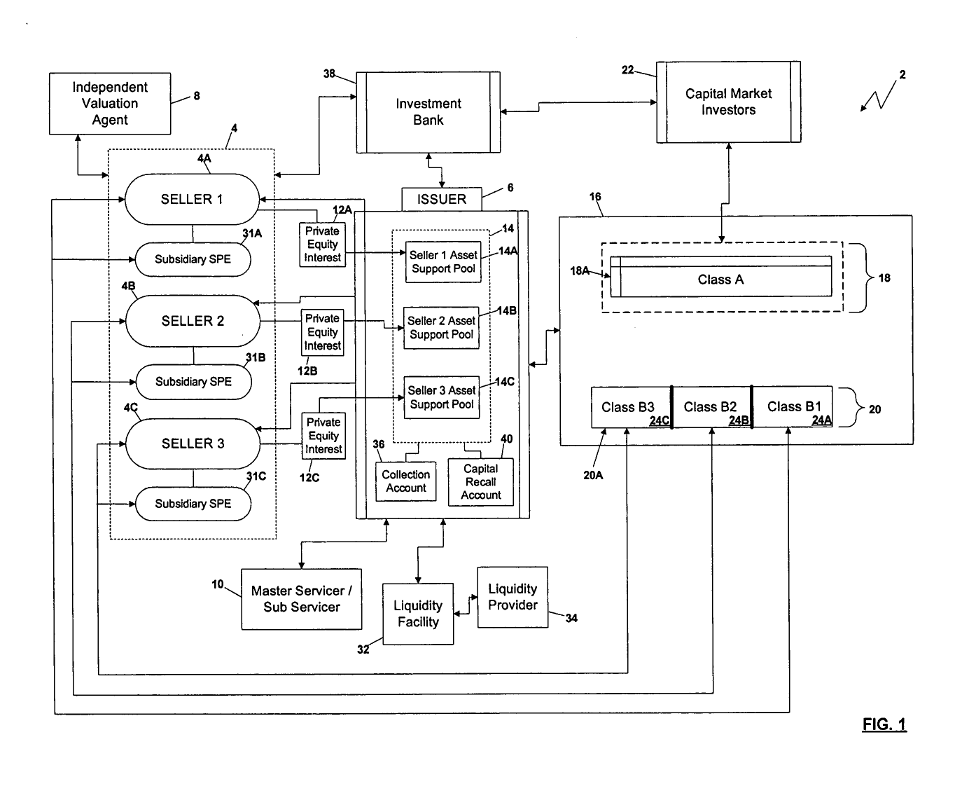

With reference to FIG. 1, various embodiments of a securitization structure 2 provided in accordance with the present invention are illustrated. A plurality of sellers 4, including Seller 1 (4A), Seller 2 (4B), and Seller 3 (4C) enter into agreement(s) to sell limited partnership interests in private equity funds (herein sometimes “assets” or “private equity interests”) to an issuer 6. It can be understood that while private equity interests are employed to illustrate various aspects of the present invention, other types of interests may be equally suitable and applicable to the present invention. Public equity interests, for example, may be applied in accordance with various embodiments of securitizations described herein. It can be appreciated that the plurality of sellers 4 may comprise any number of sellers suitable for practice of the present invention. In certain embodiments, the issuer 6 may be considered a private equity fund of fund investment vehicle for the plurality of sellers 4. The issuer 6 may be structured as a bankruptcy-remote, special purpose entity (“SPE”) with respect to the activities of the plurality of sellers 4.

In various aspects, each seller 4A, 4B, 4C may transfer without recourse all of its rights and obligations in the private equity interests to the issuer 6. As a holder of the private equity interests, the issuer 6 is obligated to fund capital calls made pursuant to capital commitments thereunder (discussed below in more detail), which capital calls may be required by general partners associated with the private equity interests to finance, for example, additional investments and/or to pay management fees or other expenses. In various aspects, the assets sold to the issuer 6 may be priced at a fair market value as determined by one or more independent valuation agents 8.

A master servicer or sub-servicer 10 may also be associated with the issuer 6. In various embodiments, the master servicer/sub-servicer 10 monitors the private equity interests held by the issuer 6 and communicates with the plurality of sellers 4, note holders, and/or investors on the performance of assets held by the issuer 6. Subject to certain predetermined collateral limitations, but at its discretion, the master servicer/sub-servicer 10 may sell, transfer, or pledge assets of the issuer 6 to one or more third parties. Under certain circumstances, one of the plurality of sellers 4 may act as a sub-servicer of the issuer 6.

In various embodiments, each seller 4A, 4B, 4C of the plurality of sellers 4 sells an asset portion 12A, 12B, 12C (respectively) to the issuer 6. In various aspects, and as described above, the asset portions 12A, 12B, 12C may include interests in private equity. The asset portions 12A, 12B, 12C sold to the issuer 6 are held within a total asset pool 14 associated with the issuer 6. In addition, a plurality of asset support pools 14A, 14B, 14C may be established as part of the total asset pool 14. Each of the asset support pools 14A, 14B, 14C corresponds on a seller-by-seller basis with the asset portion 12A, 12B, 12C sold by each seller 4A, 4B, 4C. In one example of operation of the securitization, each seller 4A, 4B, 4C may sell assets equivalent to less than 50% of the total assets sold to the issuer 6 by all of the sellers 4. In another example, any one of the sellers 4A, 4B, 4C (e.g., an individual investor) may contribute assets equivalent to more than 50% of the total assets sold to the issuer 6 by the plurality of sellers 4.

In various embodiments of the invention, the issuer 6 may finance the purchase of the asset portions 12A, 12B, 12C through the issuance of a plurality of financial instruments 16 divided into at least two tranches 18, 20. The first tranche 18 may include Class A financial instruments 18A (sometimes referred to as “Class A notes”), for example, which can be considered senior financial instruments. The second tranche 20 may include Class B financial instruments 20A (sometimes referred to as “Class B preferred shares”), for example, which can be considered subordinated financial instruments. The Class A instruments 18A may be considered cross-collateralized instruments backed by the total asset pool 14 held by the issuer 6. In certain embodiments, the Class A instruments 18A may be rated (e.g., “AAA” or investment grade). The Class B instruments 20A may also be rated (e.g., “B/B2” or non-investment grade) or may be unrated. The Class B instruments 20A may comprise equity interests in the issuer 6, for example, or represent residual rights in the assets of the issuer 6. It can be appreciated that the number of classes of the plurality of financial instruments 16 is provided merely to illustrate various aspects of the present invention. Any suitable number of classes, tranches, or subtranches associated with the plurality of financial instruments 16 may be applied within the scope of the present invention.

In various embodiments, the Class A instruments 18A may be sold by the issuer 6 to an investment bank 38, who in turn may resell the Class A instruments 18A to one or more capital market investors 22. In various aspects, the Class B instruments 20A may be distributed to the plurality of sellers 4, their subsidiaries, and/or SPEs associated with the sellers 4. The Class B instruments 20A may be customized and backed by the asset support pools 14A, 14B, 14C, which are associated with the particular asset portion 12A, 12B, 12C sold to the issuer 6 by each seller 4A, 4B, 4C (as described above). It can be seen that each of a plurality of subtranches 24A, 24B, 24C comprises a portion of the Class B instruments 20A. Each of the subtranches 24A, 24B, 24C is associated with a corresponding asset support pool 14A, 14B, 14C of the issuer 6. Therefore, each subtranche 24A, 24B, 24C within the Class B instruments 20A is collateralized by, or represents a residual interest in, only the private equity interests sold to the issuer 6 by one seller and held within one of the corresponding asset support pools 14A, 14B, 14C. For example, the subtranche 24A comprising the Class B1 instruments is associated with and collateralized by the asset support pool 14A corresponding to the seller 4A. Also, the subtranche 24B comprising the Class B2 instruments is associated with the asset support pool 14B corresponding to the seller 4B. Furthermore, the subtranche 24C comprising the Class B3 instruments is associated with the asset support pool 14C corresponding to the seller 4C. In certain embodiments, additional financial instruments may be subordinated to the Class B instruments 20A, for example, and incorporated into the plurality of instruments 16. It can be seen that such additional subordinated instruments offer the potential for additional subtranches or grouping(s) of subtranches to be associated with each asset support pool 14A, 14B, 14C.

In various embodiments of the invention, each seller 4A, 4B, 4C receives cash generated from the sale of the Class A instruments 18A to the capital market investors 22. The generated cash is apportioned and distributed to the plurality of sellers 4 in accordance with the asset portion 12A, 12B, 12C initially contributed to the issuer 6 by each seller 4A, 4B, 4C. For example, if seller 4A contributes one-third (in terms of fair market value) of the total assets sold to the issuer 6, seller 4A should receive one-third of the cash generated by issuance and sale of the Class A instruments 18A.

In certain embodiments of the present invention, a liquidity facility 32 may be optionally associated with the issuer 6. The issuer 6 may enter into a liquidity swap or revolving liquidity facility 32 arrangement with a counter-party or liquidity provider 34 that commits to advance funds to the issuer 6 for payment of certain priority amounts comprising, for example, accrued interest and commitment fees on the liquidity facility 32, interest on the Class A instruments 18A, and/or administrative fees or servicing fees (see below—discussion of priority amounts). In various aspects, the liquidity facility 32 provides funds to the extent that amounts on deposit in a collection account 36 associated with the issuer 6 are insufficient. The collection account 36 generally comprises amounts received in respect of distributions on the private equity interests held by the issuer 6. In certain aspects, the liquidity provider 34 is required to have a minimum short-term rating (e.g., “A-1+” from S&P or “P-1” from Moody's). If the liquidity provider 34 fails to maintain the required rating, it may be required to post collateral as required by one or more rating agencies and/or assign its rights and obligations to a replacement counter-party having the required ratings. In other aspects, the liquidity provider 34 is not one of the sellers 4A, 4B, 4C and is not entitled to a direct or indirect right to reimbursement from any of the sellers 4A, 4B, 4C, but rather may only look to the collateral of the issuer 6 for payment. It can be appreciated that use of a liquidity facility 32 may be necessary for the issuer 6 in view of the nature of cash flows associated with private equity interests.

The securitization may be structured such that no single seller 4A, 4B, 4C consolidates the issuer 6 for accounting purposes and, therefore, the debt issued by the issuer 6 and sold to the capital market investors 22 should be deemed “off balance sheet” for the sellers 4A, 4B, 4C. In certain aspects, the issuer 6 should be considered a variable interest entity (“VIE”) subject to appropriate treatment under applicable accounting laws, regulations, rules and/or guidelines (e.g., “FIN46(R)”). Each of the sellers 4A, 4B, 4C has variable interests in the issuer 6, and none of the sellers 4A, 4B, 4C is exposed to the majority of the expected loss of the assets in the issuer 6. Thus, none of the sellers 4A, 4B, 4C should be deemed to be a primary beneficiary of the issuer 6. Because the first tranche 18 comprising the Class A instruments 18A is collateralized by the total asset pool 14, the issuer 6 should not be bifurcated into separate VIEs, or silos, with separate assets and liabilities but rather should be treated as one entity for analysis of consolidation. In addition, the securitization may be structured such that the assets of the issuer 6 are not substantively consolidated with any individual seller 4A, 4B, 4C, in the event of an insolvency of one or more of the sellers 4A, 4B, 4C, for example, for purposes of applicable insolvency law.

As described above, the issuer 6 issues a plurality of financial instruments 16 that may be drawn upon to meet capital calls. In various embodiments, and with particular regard to sellers 4 that are institutions, the Class B instruments 20A may be purchased by a subsidiary SPE 31A, 31B, 31C associated with each seller 4A, 4B, 4C (respectively). The subsidiary SPEs 31A, 31B, 31C may be bankruptcy-remote, wholly owned special purpose subsidiaries of each seller 4A, 4B, 4C and/or may be formed as statutory trusts or limited liability companies, for example. The Class B instruments 20A may include a commitment of funds that may be drawn over time and therefore may have a funded balance and an unfunded commitment. In various aspects, the subsidiary SPEs 31A, 31B, 31C established by the institutional sellers 4A, 4B, 4C may purchase Class B instruments 20A. The unfunded commitment on each subtranche 24A, 24B, 24C of the Class B instruments 20A owned by each subsidiary SPE 31A, 31B, 31C may be equal to the total unfunded commitments of the corresponding asset portion 12A, 12B, 12C. In other aspects, the subsidiary SPEs 31A, 31B, 31C may be required to meet minimum ratings of AA/Aa2 or better, for example, or another suitable ratings threshold. If a subsidiary SPE 31A, 31B, 31C does not meet this requirement or an equivalent rating requirement, the subsidiary SPE 31A, 31B, 31C may be required to post collateral against the undrawn portion of the Class B instruments 20A it owns and/or receive credit support from an entity that does meet the rating requirements that is also not the seller 4A, 4B, 4C associated with the subsidiary SPE 31A, 31B, 31C.

With regard to sellers 4 who are individuals, Class A instruments 18A having a funding feature may be issued to the individual sellers 4 by the issuer 6 to facilitate meeting capital calls. In certain embodiments, the Class A instruments 18A may be held directly by the individual sellers 4 or may be held by third parties or other entities that deal with the individual sellers 4. In addition, the Class B instruments 20A may be held directly by the individual sellers 4 without the use of a wholly owned, bankruptcy remote SPE. This is in contrast to institutional sellers that establish the wholly-owned, bankruptcy remote subsidiary SPEs 31A, 31B, 31C to purchase the Class B instruments 20B, for example, to avoid consolidation of the issuer 6 while providing a vehicle for the funding of capital calls.

It can be seen that, in exchange for transferring the private equity interests comprising the asset portions 12A, 12B, 12C to the issuer 6, the sellers 4A, 4B, 4C may receive cash and interests in investment grade instruments (e.g., through the Class A instruments 18A) and below investment grade securities (e.g., through the Class B instruments 20A). In one example of practice of the present invention, for the asset portions 12A, 12B, 12C sold, each seller 4A, 4B, 4C receives approximately 40% of the fair market value in cash (generated from the sale of the Class A instruments 18A to the capital market investors 22) and approximately 60% of the fair market value in lower-rated instruments (based on issuance of the Class B instruments 20A).

In various embodiments of the invention, the transaction involving the sale of asset portions 12A, 12B, 12C to the issuer 6 can be accounted as a “true sale” for legal and accounting purposes. In various aspects, the sellers 4A, 4B, 4C cannot have call options on the assets or an automatic return of assets, for example. In addition, in certain aspects, the issuer 6 has the ability the sell the assets subject to certain restrictions. In accordance with the above discussion, the issuer 6 and each subsidiary SPE 31A, 31B, 31C (where applicable to institutional investors that employ the subsidiary SPEs 31A, 31B, 31C to purchase the Class B instruments 20A, for example) is structured as a bankruptcy-remote special-purpose entity. In other aspects, the issuer 6 grants a first-priority, perfected security interest in rights in the collection account 36 and the total asset pool 14 to an indenture trustee for the benefit of note holders (i.e., holders of the Class A instruments 18A) and the liquidity provider 34 of the liquidity facility 32. Also, due to the bankruptcy-remote nature of the issuer 6, the non-recourse nature of the securitization debt, and the non-strategic nature of portfolio investments, off-credit treatment of the securitization debt by rating agencies should be achievable. The foregoing factors contribute, at least in part, to the conclusion that the transaction involving the sale of the asset portions 12A, 12B, 12C to the issuer 6 should be deemed a true sale for legal purposes and a sale, rather than a financing, for accounting purposes.

In various embodiments of the invention, a financial entity such as the investment bank 38, for example, interacts with one or more of the plurality of sellers 4, the issuer 6, and/or the capital market investors 22. For example, the investment bank 38 may work with one of the sellers 4A, 4B, 4C to define various aspects of the structure and terms/conditions of the securitization including general collateral limitations. Examples of collateral limitations include, without limitation, a specified range of funded and unfunded assets, minimum leveraged buy-out concentrations, maximum venture concentrations, and a specified range of vintage years. Once the terms/conditions of the securitization are finalized, the investment bank 38 may offer the securitization as a financial product to one or more of the sellers 4A, 4B, 4C or other sellers. In addition, the issuer 6 may issue and sell the Class A instruments 18A, for example, to the capital market investors 22 through the investment bank 38. The investment bank 38 may act as a placement agent or an initial purchaser for marketing/selling the Class A instruments 18A to third party investors. In various aspects, the investment bank 38 may be instrumental in placing the liquidity facility 32 for the securitization. In other aspects, the investment bank 38 may serve to evaluate and determine ratings for classes of the plurality of financial instruments 16 issued by the issuer 6.

The benefits of a multi-seller structure provided in accordance with the securitization embodiments of the present invention are readily apparent. With respect to liquidity, the sellers 4A, 4B, 4C are able to generate liquidity from the Class A instruments 18A sold to the capital market investors 22 and also retain upside on the asset portions 12A, 12B, 12C contributed to the issuer 6. With respect to capital impact, by retaining rated instruments, the sellers 4A, 4B, 4C may improve regulatory capital requirements and potentially improve their credit worthiness by paying down debt with proceeds raised through the securitization. The sellers 4A, 4B, 4C may be able to recognize a gain on the sale of their respective asset portions 12A, 12B, 12C. In addition, as discussed above, no individual seller 4A, 4B, 4C is likely to be exposed to the majority of the expected losses or expected residual returns on assets held by the issuer 6. Thus, no individual seller 4A, 4B, 4C should be considered a primary beneficiary of the issuer 6 for the purposes of consolidation. It can be seen that, in certain aspects, private equity interests may be removed from the balance sheet of the sellers 4A, 4B, 4C in exchange for a combination of cash, rated instruments, and unrated instruments. Furthermore, private equity interests are generally held as an equity-like asset and the earnings (or losses) of the holder may be subject to the volatility of prevailing market conditions. Employing the securitization of the present invention, however, may provide more debt-like accounting for the private equity interests which may reduce the potentially adverse effects of volatile market conditions on financial statements of the sellers 4A, 4B, 4C.

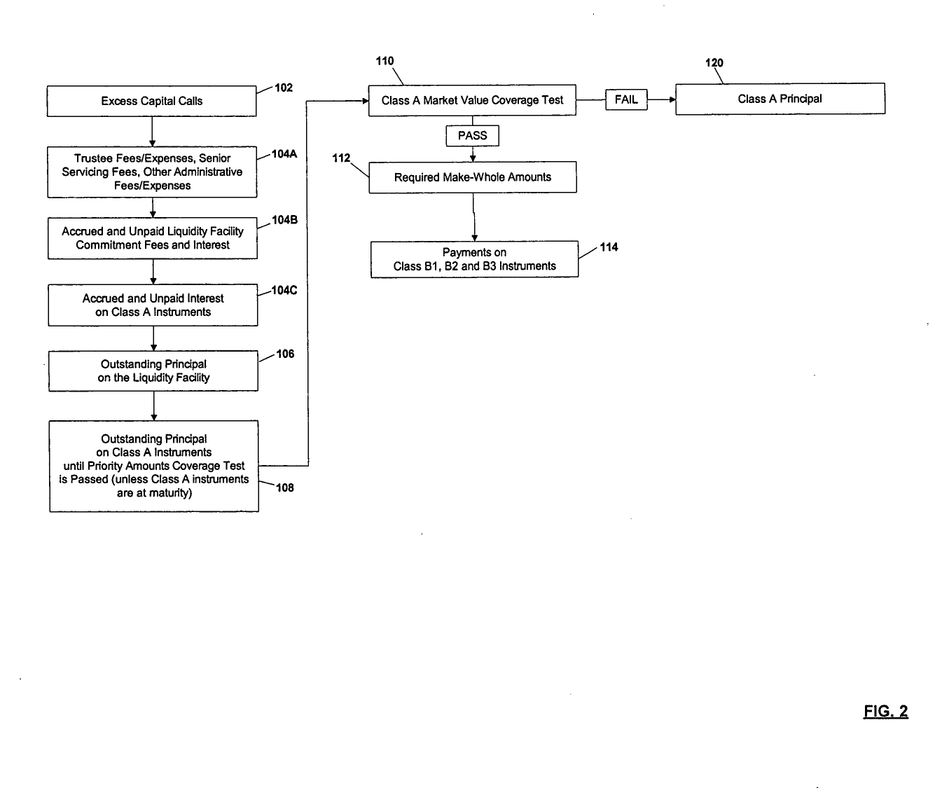

Referring now to FIG. 2, an example of a priority of payment process flow (herein sometimes “waterfall”) is provided in accordance with the securitization embodiments of the present invention. It can be appreciated that many of the aspects of the waterfall described herein are provided merely for purposes of illustration. Those in the art will appreciate that variations of elements and structure of the waterfall shown in FIG. 2 may be readily made within the scope of the present invention.

The issuer 6, as owner of the private equity interests, is obligated to fund various capital calls. Each such funding (perhaps other than funding a fee, expense or an indemnity call) reduces the amount of future capital calls for which the issuer 6 is liable and increases the value of the private equity interests. In accordance with the discussion above, the issuer 6 may fulfill its obligation to fund capital calls by issuing the Class A instruments 18A and/or the Class B instruments 20A, for example, which can be drawn over time to meet capital calls to the extent of the availability of unfunded commitments. In step 102, to the extent that there are calls for fees, expenses and/or indemnities that exceed the ability of the issuer 6 to draw on the instruments 16, the issuer 6 may fund such liabilities from amounts available in the collection account 36. The obligation of the issuer 6 to fund such excess capital calls may rank senior in the waterfall to other priority amounts (see below—discussion of priority amounts), including the payment of interest on the Class A instruments 18A, for example. The Class A instruments 18A may have priority over the Class B instruments 20A, for example, in terms of the priority of payment provided in the waterfall.

In steps 104A through 104C, in various examples of practice of the invention, the issuer 6 may apply distributions (from the private equity interests) held in the collection account 36 to pay priority amounts which comprise one or more of the following: (1) trustee fees/expenses, senior servicing fees, other administrative fees/expenses (see step 104A); (2) accrued and unpaid liquidity facility 32 commitment fees and interest (see step 104B); and/or, (3) accrued and unpaid interest on the Class A instruments 18A (see step 104C). The issuer 6 also may draw on the liquidity facility 32, for example, as needed to cover the priority amounts. If there are remaining distributions after the priority amounts are paid, the distributions may be applied to pay outstanding principal of the liquidity facility 32 in step 106. In various aspects, after payment of priority amounts (steps 104A-104C) and outstanding liquidity facility 32 principal (step 106), remaining distributions may be applied to pay down the principal of the Class A instruments 18A up to an amount determined by a priority amount coverage test (see below—discussion of coverage tests) (see step 108). This assures that cash is not accumulated by the issuer 6, but rather is used to pay down the outstanding principal amounts thereby reducing future interest liabilities. When the priority amount coverage test is passed, then the waterfall procedure proceeds to step 110 where a market value coverage test is checked. So long as the market value coverage test is passed in step 110, the waterfall procedure proceeds to step 112 wherein remaining proceeds may be used for make-whole payments to one or more holders of the Class B instruments 20A. If the market value coverage test fails in step 110, the waterfall proceeds to step 120 wherein remaining proceeds may again be used for making principal payments on the Class A instruments 18A.

In general, coverage tests (e.g., priority amount coverage tests or market value tests) may be employed to govern cash flow to subordinated financial instruments (e.g., subtranches 24A, 24B, 24C of the Class B instruments 20A) versus more senior financial instruments (e.g., Class A instruments 18A) or other commitments of the issuer 6. A priority amount coverage test may, in certain embodiments, be designed to ensure that distributions of the assets are retained until projected priority amounts in aggregate are covered. A market value coverage test may be designed to ensure that the market value of collateral maintains a minimum coverage over the par value of liabilities. When the coverage tests are passed/satisfied, cash may flow to the subtranches of the subordinated financial instruments (subtranches 24A, 24B, 24C), for example; otherwise, cash is applied to the more senior financial instruments, for example. It can be appreciated that principal payments may be made until the maturity date of the Class A instruments 18A when the principal on the Class A instruments 18A will be paid in full.

In certain examples of practice of the present invention, the priority amounts coverage test is satisfied if the total liquidity amount (equal to the sum of the available undrawn commitment under the liquidity facility 32 and amounts held in the collection account 36) equals or exceeds the cumulative estimated priority amounts through and including the stated maturity of the securitization. The priority amounts coverage test may be recalculated quarterly, for example, or on another periodic or non-periodic basis, in connection with each payment date. The calculation may take into account reductions in the principal amounts as the Class A instruments 18A are repaid and the time remaining until maturity. For purposes of determining compliance with the priority amounts coverage test, estimated future priority amounts may be calculated, for example, based on assumptions regarding LIBOR and/or other assumptions such as the assumption that no additional principal will be paid on the Class A instruments 18A following the date of such determination until the stated maturity of the Class A instruments 18A.

In step 110, an appropriate market value coverage test may be applied to the Class A instruments 18A. In certain aspects, the coverage test for a class (e.g., for the benefit of the Class A instruments 18A) may be deemed satisfied/passed if the coverage ratio equals or exceeds the minimum required coverage ratio specified for the class. For example, the coverage ratio for the coverage test may equal (NAV+CV+CA)/(N+LF), wherein “NAV” is the aggregate net asset value of the private equity interests (as most recently determined by the general partners of the respective funds); “CV” is the mark-to-market value to the issuer 6 of any interest rate hedging instruments (e.g., an interest rate cap); “CA” is the aggregate amount on deposit in the collection account 36; “N” is the aggregate principal amount of the class plus the aggregate principal amount of each class ranking senior in priority to the class (including deferred interest thereon); and, “LF” is the outstanding principal balance under the liquidity facility 32. If the appropriate market value coverage test has been satisfied or passed in step 110, distributions may be applied in step 112 for any required make-whole payments. If the coverage test of step 110 fails, available distribution amounts may be applied to principal of the Class A instruments 18A, for example, in step 120.

In step 112, remaining distribution amounts may be allocated in accordance with required “make-whole” amounts. As discussed above, each of the sellers 4A, 4B, 4C may have been the source of certain interests associated with a corresponding asset support pool 14A, 14B, 14C. Moreover, each such seller (or, e.g., its subsidiary SPE) purchased a subtranche 24A, 24B, 24C tied to the corresponding asset support pool 14A, 14B, 14C (respectively). In accordance with the present invention, payments to each subtranche 24A, 24B, 24C depend on performance of the interests within that subtranche's corresponding asset support pool 14A, 14B, 14C. The issuer 6 tracks the distributions generated by each asset support pool 14A, 14B, 14C and the relative amounts contributed by each toward priority payments such as interest and principal on the Class A instruments 18A, liquidity facility fees, administrative fees, etc. For example, seller 4A may be the source of interests in asset support pool 14A that represented 30% by fair market value of the total asset support pool 14; seller 4B may be the source of interests in asset support pool 14B that represented 45% by fair market value of the total asset support pool 14; and, seller 4C may be the source of interests in asset support pool 14C that represented 25% by fair market value of the total asset support pool 14. Each of the asset support pools 14A, 14B, 14C should support a corresponding percentage of payments. In the context of the present example, the asset support pool 14A should support 30% of the payments. If one or more of the asset support pools 14A, 14B, 14C cannot support payments in accordance with its corresponding percentage, then the issuer 6 tracks one or more make-whole amounts that account for short-falls made up for by one or more of the other asset support pools. Accordingly, remaining amounts from the collection account 36 may be paid in step 112 to the holders of the one or more subtranches associated with the one or more make-whole amounts. As can be appreciated, in the case of multiple make-Whole amounts, make-whole payments may be allocated among the holders of multiple subtranches in accordance with the relative proportions of their corresponding make-whole amounts. A benefit of make-whole payments is a potential reduction in risk exposure of the portfolio of one seller to the portfolios of the other sellers. This arrangement also may make the negotiation process more efficient for forming a plurality of sellers 4 in connection with structuring the securitization.

After the make-whole payments are made, in step 114 remaining distribution amounts may be paid to the holders of the Class B instruments 20A (e.g., pro rata among the subtranches 24A, 24B, 24C).

In certain embodiments of the present invention, various private equity interests may have maturity dates or extension options, for example, beyond the stated maturities of the plurality of instruments 16. As a result, the issuer 6 may need to commence an orderly liquidation of the private equity interests prior to the maturity of the instruments 16 (e.g., one year prior to maturity). In certain aspects, however, after payment in full of the investment grade classes of the instruments 16 (including accrued and unpaid interest) and all other liabilities of the issuer 6 other than the non-investment grade classes of the instruments 16, the issuer 6 may distribute all or a portion of the private equity interests in kind, in lieu of any remaining payments to the holders of the non-investment grade classes of the instruments 16.

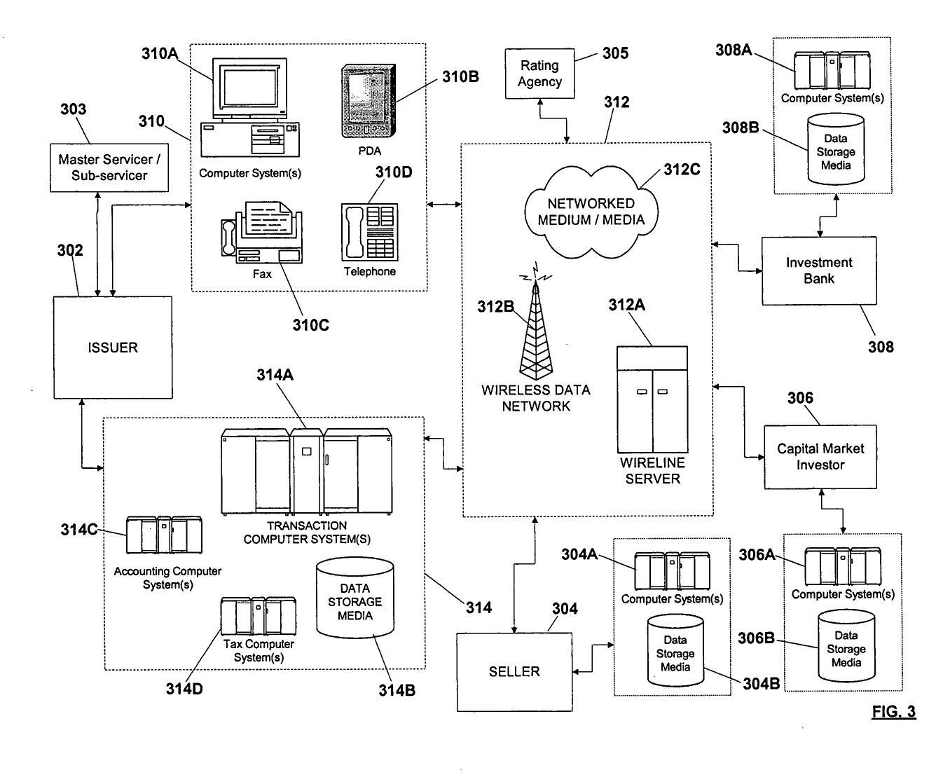

Referring now to FIG. 3, various system and computer-readable media embodiments provided in accordance with the present invention are illustrated. As shown, an issuer 302 may communicate and/or exchange data with a seller 304, a capital market investor 306, and/or an investment bank 308. In various aspects, the issuer 302 may be operatively associated with one or more communications devices 310 such as, for example and without limitation, a computer system 310A, a personal digital assistant 310B, a fax machine 310C, and/or a telephone 310D (e.g., a wireline telephone, a wireless telephone, a pager, and the like), and/or other like communication devices. The communication devices 310 permit the issuer 302, the seller 304, the capital market investor 306, and/or the investment bank 308 to communicate between/among each other through one or more communication media 312, such as by employing electronic mail communicated through one or more computer systems, for example. The communication media 312 may include, for example and without limitation, wireline communication means such as a wireline server 312A, a wireless data network 312B, and/or a connection through a networked medium or media 312C (e.g., the Internet, an extranet, an intranet, a wide area network (WAN), and/or a local area network (LAN)). In one example, a master servicer/sub-servicer 303 may be in communication with the issuer 302 to model performance of the issuer 302, generate and provide financial reports, calculate payments in accordance with a waterfall, and/or perform other tasks for the issuer 302.

In addition, the issuer 302 (as well as any one or more of the seller 304, the capital market investor 306, and/or the investment bank 308) may be operatively associated with one or more data processing/storage devices such as data processing/storage devices 314, for example. The issuer 302 may be operatively associated with one or more transaction computer systems 314A, for example, and/or one or more data storage media 314B configured to receive, store, analyze and/or otherwise process data and other information in association with communications that occur between/among the issuer 302, the seller 304, the capital market investor 306, and/or the investment bank 308. In various aspects, the issuer 302 may be operatively associated, for example, with one or more accounting computer systems 314C and/or one or more tax computer systems 314D. The accounting/tax computer systems 314C, 314D may be configured for receiving, storing, and/or processing accounting/tax data, among other types of data, associated with various transactions involved in the structure of the securitization, for example. Accounting for make-whole amounts, for example, may be performed by the accounting computer systems 314C of the issuer 302. Also, the computer systems 314A of the issuer 302 may include an automated banking system, for example, for coordinating electronic transfer of funds from accounts of the issuer 302 to one or more of the sellers 304 in association with proceeds from instruments issued in accordance with a securitization.

In various aspects, the seller 304 may be operatively associated with one or more computer systems 304A and/or one or more data storage media 304B. In other aspects, the capital market investor 306 may be operatively associated with one or more computer systems 306A and/or one or more data storage media 306B. In still other aspects, the investment bank 308 may be operatively associated with one or more computer systems 308A and/or one or more data storage media 308B. For example, the investment bank 308 may employ one or more of its computer systems 308A to simulate asset scenarios or present the economic outlook of a securitization to one or more sellers 304. In another example, the investment bank 308 may communicate computer models of a securitization to a rating agency 305 for calculation of ratings for instruments offered in connection with the securitization.

It can be appreciated that one or more of the computer systems 304A, 306A, 308A, 314A, 314C, 314D and/or one or more of the data storage media 304B, 306B, 308B, 314B may be employed to communicate, store, analyze, and/or otherwise process data related to financial transactions occurring between/among the issuer 302, the seller 304, the capital market investor 306, and/or the investment bank 308.

The term “computer-readable medium” is defined herein as understood by those skilled in the art. It can be appreciated, for example, that method steps described herein may be performed, in certain embodiments, using instructions stored on a computer-readable medium or media that direct a computer system to perform the method steps. A computer-readable medium can include, for example and without limitation, memory devices such as diskettes, compact discs of both read-only and writeable varieties, digital versatile discs (DVD), optical disk drives, and hard disk drives. A computer-readable medium can also include memory storage that can be physical, virtual, permanent, temporary, semi-permanent and/or semi-temporary. A computer-readable medium can further include one or more data signals transmitted on one or more carrier waves.

As used herein, a “computer” or “computer system” may be, for example and without limitation, either alone or in combination, a personal computer (PC), server-based computer, server, main frame, microcomputer, minicomputer, laptop, personal data assistant (PDA), cellular phone, pager, processor, including wireless and/or wireline varieties thereof, and/or any other computerized device capable of configuration for processing data for either standalone application or over a networked medium or media. Computers and computer systems disclosed herein can include memory for storing certain software applications used in obtaining, processing, storing and/or communicating data. It can be appreciated that such memory can be internal or external, remote or local, with respect to its operatively associated computer or computer system. The memory can also include any means for storing software, including a hard disk, an optical disk, floppy disk, ROM (read only memory), RAM (random access memory), PROM (programmable ROM), EEPROM (extended erasable PROM), and other suitable computer-readable media.

It is to be understood that the figures and descriptions of embodiments of the present invention have been simplified to illustrate elements that are relevant for a clear understanding of the present invention, while eliminating, for purposes of clarity, other elements. Those of ordinary skill in the art will recognize, however, that these and other elements may be desirable for practice of various aspects of the present embodiments. However, because such elements are well known in the art, and because they do not facilitate a better understanding of the present invention, a discussion of such elements is not provided herein.

It can be appreciated that, in various embodiments disclosed herein, a single component/element/entity can be replaced by multiple components/elements/entities and multiple components/elements/entities can be replaced by a single component/element/entity, to perform a given function or functions. Except where such substitution would not be operative to practice aspects of the present embodiments, such substitution is considered to be within the scope of the present invention.

Examples presented herein, including operational examples, are intended to illustrate potential implementations of the present invention. It can be appreciated that such examples are intended primarily for purposes of illustration. No particular aspect or aspects of the example embodiments described herein are intended to limit the scope of the present invention.

It should be appreciated that figures presented herein are intended for illustrative purposes and are not intended as construction drawings. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of parts/elements/steps/functions may be made within the principle and scope of the invention without departing from the invention as described in the claims.

1. A multi-seller securitization structure comprising:
an issuer structured to receive at least one asset portion from each seller of a plurality of sellers, each said asset portion comprising an asset support pool of a total asset pool of said issuer;
said issuer structured to issue at least two tranches of financial instruments, wherein a first of said tranches includes at least one senior instrument, and a second of said tranches includes at least one subordinated instrument, said second tranche comprising a plurality of subtranches, wherein at least one subtranche of said plurality of subtranches is structured to be associated with at least one of said asset support pools; and,
said issuer being structured for making at least one make-whole payment in connection with at least one make-whole amount tracked by said issuer in association with at least one of said asset support pools.

2. The securitization structure of claim 1, wherein each said asset support pool represents a corresponding percentage of the fair market value of said total asset support pool.

3. The securitization structure of claim 2, wherein at least one of said asset support pools supports at least one payment in association with at least one of said financial instruments in accordance with said corresponding percentage of said asset support pool.

4. The securitization structure of claim 3, further comprising said issuer being structured for tracking at least one said make-whole amount if at least one of said asset support pools cannot support said corresponding percentage payment.

5. The securitization structure of claim 1, further comprising at least one grouping of said plurality of subtranches being structured for association with at least one of said asset support pools.

6. The securitization structure of claim 1, wherein at least one of said asset portions includes an equity interest.

7. The securitization structure of claim 6, wherein said equity interest includes a private equity interest.

8. The securitization structure of claim 6, wherein said equity interest includes a public equity interest.

9. The securitization structure of claim 1, wherein at least one of said plurality of sellers is an institution.

10. The securitization structure of claim 1, wherein at least one of said plurality of sellers is an individual investor.

11. A method for structuring a multi-seller securitization structure, said method comprising:
structuring an issuer to receive at least one asset portion from each seller of a plurality of sellers, each said asset portion comprising an asset support pool of a total asset pool of said issuer;
structuring said issuer to issue at least two tranches of financial instruments, wherein a first of said tranches includes at least one senior instrument, and a second of said tranches includes at least one subordinated instrument, said second tranche comprising a plurality of subtranches, wherein at least one subtranche of said plurality of subtranches is structured to be associated with at least one of said asset support pools; and,
structuring said issuer for making at least one make-whole payment in connection with at least one make-whole amount tracked by said issuer in association with at least one of said asset support pools.

12. The method of claim 11, wherein each said asset support pool represents a corresponding percentage of the fair market value of said total asset support pool.

13. The method of claim 12, further comprising structuring at least one of said asset support pools to support at least one payment in association with at least one of said financial instruments in accordance with said corresponding percentage of said asset support pool.

14. The method of claim 13, further comprising structuring said issuer for tracking at least one said make-whole amount if at least one of said asset support pools cannot support said corresponding percentage payment.

15. The method of claim 11, further comprising structuring at least one grouping of said plurality of subtranches for association with at least one of said asset support pools.

16. The method of claim 11, further comprising structuring at least one of said asset portions to include an equity interest.

17. The method of claim 16, wherein said equity interest includes a private equity interest.

18. The method of claim 16, wherein said equity interest includes a public equity interest.

19. The method of claim 11, wherein at least one of said plurality of sellers is an institution.

20. The method of claim 11, wherein at least one of said plurality of sellers is an individual investor.
